(19) United States
(12) Patent Application Publication
(10) Pub. No.: US 2010/0107544 A1
(43) Pub. Date: May 6, 2010

(54) BRACKET FOR SPIGOT OR TELESCOPING TYPE JOINTS BETWEEN MEMBERS

(75) Inventor: Barry Gray, Redland Bay (AU)

Correspondence Address: LANDO & ANASTASI, LLP, ONE MAIN STREET, SUITE 1100, CAMBRIDGE, MA, 02142, US

(73) Assignee: IN2IMAGE PTY LTD, Queensland (AU)

(21) Appl. No.: 12/521,396

(22) PCT Filed: Dec. 5, 2007
(86) PCT No.: PCT/AU07/01872

§ 371 Date: Jan. 21, 2010

(30) Foreign Application Priority Data
Dec. 5, 2006 (AU) 2006906810

(51) Int. Cl. E04C 2/38; F16M 13/00; B23P 11/00

(52) U.S. Cl. 52/588.1; 248/309.1; 52/592.1; 29/428

(57) ABSTRACT

Disclosed herein is a panel having at least one locating bracket having a substantially C-shaped attachment portion having an opening along at least one sidewall and a flange adapted to attach the at least one bracket relative to a surface, a plurality of first members disposed in a first direction, at least one second member disposed in a second direction, at least one side surface of at least one member being shaped to engage the C-shaped attachment portion of the locating bracket, wherein at least a part of the C-shaped attachment portion is adapted to be coplanar with at least one side surface of the at least one member.

### FIELD OF THE INVENTION

The present invention relates to brackets and panels and particularly to improved brackets and panels having good strength characteristics and minimal complexity allowing self-assembly.

### BACKGROUND ART

Brackets, panels and brackets for securing panels are available in the marketplace and are quite common.

Panels have many different forms and the present invention is directed towards providing a panel with a series of members which are fixed in position extending in a first direction and which may have at least one member extending in a different direction in order to act as a bracing member.

Typical examples of panels similar to those of the present invention are decorative wooden slat panels used atop metal fences, lattice panels and other slatted panels used for decorative use or use as a selective barrier to allow air to flow through the panel and to prevent larger objects passing.

The panels of the prior art such as those described above are often formed prior to installation and are generally located and secured between a pair of support pillars or walls. The facing surfaces of the support pillars or walls are generally provided with an elongate groove or channel into which the edges of the panels are inserted (generally from above or below) and then the ends of the groove or channel are occluded to prevent the panel from being removed.

Edges of the panel have in the past been inserted into brackets for fixing the panel in position but these brackets have generally been cumbersome and not aesthetically pleasing. The brackets of the prior art have been used to engage the panel surround (where provided) or individual members of the panel. Where prior art brackets have engaged individual members of a panel, they have generally been provided as a tubular member into which an end of the panel member is inserted. This enlarges the end of the member and can sometimes result in a panel not being appropriate for the size of the opening into which it is supposed to fit.

Further to this, the pre-fabricated panels are often manufactured following a quotation for the panel and are thus a made-to-measure panel which are relatively precisely manufactured. For most panels of the prior art, the problem of fitting an oversized panel into an opening has resulted in on-the-spot alterations to the panel using a saw or similar cutting tool to decrease the size of the panel. For panels which are manufactured too small for the fixtures to secure, the solution is not as simple and generally involves construction of a fresh panel or the use of spacing members secured to the support pillars or walls to which the panel is then attached.

It is therefore an object to provide a bracket and a panel including a bracket that is simple and convenient to use and install as well as being a panel that allows a do-it-yourself construction by a relatively unskilled worker with a limited array of tools.

It will be clearly understood that if a prior art publication is referred to herein, this reference does not constitute an admission that the publication forms part of the common general knowledge in the art in Australia or in any other country.

### SUMMARY OF THE INVENTION

The present invention is directed to a bracket and panel including same, which may at least partially overcome at least one of the above-mentioned disadvantages or provide the consumer with a useful or commercial choice.

In one form, the invention resides in a panel having
i. at least one locating bracket having
   a. a substantially C-shaped attachment portion having an opening along at least one sidewall and
   b. a flange adapted to attach the at least one bracket relative to a surface,
ii. a plurality of first members disposed in a first direction,
iii. at least one second member disposed in a second direction, at least one side surface of at least one member being shaped to engage the C-shaped attachment portion of the locating bracket,
   wherein at least a part of the C-shaped attachment portion is adapted to be coplanar with at least one side surface of the at least one member.

In a second form, the invention resides in a method for assembling a panel, the panel having
i. at least one locating bracket having
   a. a substantially C-shaped attachment portion having an opening along at least one sidewall and
   b. a flange adapted to attach the at least one bracket relative to a surface,
ii. a plurality of first members disposed in a first direction,
iii. at least one second member disposed in a second direction, at least one side surface of at least one member being shaped to engage the C-shaped attachment portion of the bracket,
   wherein the method includes the step of inserting the member into the C-shaped attachment portion until at least a part of the C-shaped attachment portion is coplanar with at least one side surface of the panel member and securing the bracket to the member.

The panel of the invention is particularly well suited to use as a fence panel or inlay panel (such as an aesthetic or feature panel) for a fence or similar barrier. As such and without wishing to be limited, the panel formed according to the invention may be used as a gate panel (or feature panel in a gate), a detail or feature panel for a garage, carport, house or other structure, a patio barrier panel such as a railing or wall, a detail or feature panel for a roof gable or external window shade. The panel of the invention may alternatively find use as, or as a part of, a pergola, an internal shutter wall, balustrade (internal or external) or as decking.

It is particularly preferred that the panel be manufactured for sale in kit or modular form. As such, the panel should be particularly adapted for post-sale assembly in such a manner as to be easy to assemble for a person of average do-it-yourself skill. The panel of the invention is particularly well adapted to this application due to the manner in which the panel is assembled and mounted enables a product with a standard dimension to be manufactured and used in a space that is up to 300 mm larger in dimension quickly, simply and without custom manufacture.

The panel should be a barrier panel and according to a particularly preferred form, the panel will have slat members alternated with openings between the slats. However, when a solid barrier is required, without openings, the panel of the present invention is easily adapted to this form which can also be used as decking.

The panel of the invention can be manufactured of any material suitable for the purpose. However, preferred materials of construction are plastic and metal with a more preferred material being wood for its strength but also due to its aesthetic qualities.

According to a particularly preferred embodiment, the panel will include a series of members in the first direction and members in the second direction which fix the members in the first direction together and/or brace the members in the first direction. The panel will also usually include at least one and generally a plurality of brackets to secure the panel in position in or relative to an opening.

There are generally a plurality of first members arrayed in a first direction. Each of the first members will generally be slat members. The direction depends upon the desire of the user and therefore in use and after assembly, the first members may be oriented horizontally, vertically or angled. The first members will typically be elongate members. The actual length of the first members will typically depend upon the size of the barrier or panel required.

The slat members will typically have a rectangular cross-section. The corners of the rectangle may be smoothed to create a more aesthetically pleasing appearance. Each slat member will also typically include a number of predrilled openings to allow for the use of fasteners, particularly if a hard, brittle material is used. The slats may be oriented such that the longer of the two dimensions is parallel to the longer of the two dimensions of the second members or the shorter of the two dimensions may be parallel to the longer of the two dimensions of the second members. The configuration may also be taken into account for strength purposes.

Importantly, the first members may be used as a top or bottom rail for the panel as well as slats. The top or bottom rail will generally be a border rail to tidy the appearance of the panel, to protect the ends of the members from water damage or to provide structural support to the panel.

The members may of course also be of any other cross-section required by a user or manufacturer of the panels. For example, a round member may be preferred by a consumer for aesthetic reasons.

There is at least one, and generally more than one, second member arrayed in a second direction. There will typically be a second member provided at each end of the panel and there may be one or more second members provided along the panel to provide stiffening or bracing to the panel.

The second members will typically be elongate members. The actual length of the second members will typically depend upon the size of the barrier or panel required.

As with the first members, each of the second members will generally be slat members. The slat members will typically have a rectangular cross-section. The corners of the rectangle may be smoothed to create a more aesthetically pleasing appearance. Each slat member will also typically include a number of predrilled openings to allow for the use of fasteners, particularly if a hard, brittle material is used.

The second members provided at or adjacent the ends of the panel are preferably adapted to allow the use of the bracket to secure the panel in position. Preferably, the coplanar portion of the C-shaped attachment portion of the bracket and the first member which it engages faces the second member located at the ends of the panel.

Each member (first or second) will typically have one or more rebated sections. The location and configuration of the rebated sections will differ between the first and second members, but will preferably be correspondingly shaped to engage each other when the panel is assembled.

Each first member will typically include at least one, and generally a pair of, rebated portions at or adjacent each end of the first member. Each of the rebated portions will preferably be a shoulder rebate, or portion removed from a corner of the first member over a predetermined length of the first member. When a pair of rebated portions are provided on each end of the first member, the corner portions are preferably removed from corners on the same side of the first member and not diagonally opposite corners. A rebated portion may be formed at all four corners of each end of the first member, or further, a rebated portion may be provided such that each end is reduced in dimension in both directions; that is, the entire end portion of the first member may be reduced in size such that the C-shaped attachment portion surrounds the end portion of the first member and is flush with the unrebated portion of the first member.

The rebated portions of the first member may extend along the first member approximately 200 mm from each end, but suitably will extend approximately 75 mm inward. This allows positioning of a second member which may be approximately 42 mm wide, relative to the first members, with approximately 35 mm of overhang of the first member outwardly past the edge of the second member. In this instance, once the bracket is fitted to the first member, the second member will cover the rebated portions of the first member. The 35 mm overhang measurement may be amended. The rebated portions may form a raised tongue extension portion on each end of the first member between the rebated portions. The tongue extension portion will preferably be received between sidewalls of the C-shaped attachment portion.

There will typically be more than one rebated portion provided at the same end of the first members. Each end of the first member may be rebated to different depths and/or position to form a stepped profile at the end of the first member. In particular, the tongue extension portion formed by the rebating of the corners of the ends of the first members to form a primary rebate may be further rebated to provide at least one secondary rebated portion. The secondary rebated portion will typically be narrower and shallower than the primary rebated portion and is formed over a part only of the length of the primary rebated portion. Generally, there will be a secondary rebated portion provided for each primary rebated portion.

Preferably, the primary rebated portion or primary tongue is located adjacent the end of the first member and the secondary rebated portion or secondary tongue is located inboard of the primary tongue. When both primary and secondary tongues are provided on an end of the first member, the primary tongue will usually be an L-shaped tongue when viewed from the side with a base portion of the L-shaped tongue adjacent the end of the first member and an upright portion of the L-shaped tongue extending from the base portion and toward the opposite end of the first member. The secondary tongue may stop at the full-sized or unrebated portion of the first member.

Only some of the first members used to manufacture the panel of the invention may be configured in this manner, and the number of these will generally be determined according to the size of the panel desired. The first members with the rebated portions will typically be spaced apart over the panel dimension. Preferably, the rebated first members are adapted to facilitate the use of the brackets to secure the panel in location and other first members may be of constant cross-section.

First members may be provided with the primary and secondary tongues at only one end of the member and the remainder of the member may be of constant cross-section. Where not provided with the primary and secondary rebate, such as along the length of the first member between the ends or at ends simply not provided with the primary and secondary rebated portions, preferably the rebated portions may be provided at the corner edges similar to the formation of the primary tongue, but differ in that they preferably do not extend all the way to the end of the member. In this form, the rebated portions may be separated from the end of the first member by a full-size, unrebated portion. Where this type of rebated portion is provided, the depth of the rebated portions may be similar to that of the secondary tongue. These rebated portions may also be referred to as secondary tongue, for simplicity sake, even though no primary tongue is provided in conjunction with them.

Each of the rebated portions of the first member preferably has a predrilled hole or opening associated with the rebated portion. This will particularly be the case when hard and brittle materials are used for the member.

Each of the second members will also generally be slat members. The second members will typically be elongate members. The actual length of the second members will typically depend upon the size of the barrier or panel required.

The slat members will typically have a rectangular cross-section. The corners of the rectangle may be smoothed to create a more aesthetically pleasing appearance. Each slat member will also typically include a number of predrilled openings to allow for the use of fasteners, particularly if a hard, brittle material is used. The slats may be oriented such that the longer of the two dimensions of the second member is parallel to the longer of the two dimensions of the first members or the shorter of the two dimensions of the second member may be parallel to the longer of the two dimensions of the first members. The configuration may also be taken into account for strength purposes.

Each of the second members used in the panel according to the invention will preferably include a plurality of rebated portions spaced over their length. Each rebated portion is particularly adapted to engage a secondary rebate or tongue provided on a first member to positively locate the first member relative to the second member.

Each secondary member preferably has the same configuration and spacing between the rebated portions to align the rebated portions and in turn, align the first member of the panel.

Each second member may include rebated portions in the end surfaces of the member in order to engage with the tongue portions of a first member when used as a top or bottom rail of the panel. Where provided, these rebated portions are preferably centrally located.

Again, each rebated portion preferably has a predrilled hole or opening associated with the rebated portion. The rebated portions of the second members are preferably sized and shaped to closely receive the corresponding tongue portion.

The panel of the invention includes at least one and generally multiple locating brackets, each locating bracket having a substantially C-shaped attachment portion with an opening along at least one sidewall and a flange adapted to attach the at least one bracket relative to a surface. Each bracket will typically be between 25 mm and up to 300 mm in length.

The brackets may be manufactured from any relatively light but strong material and preferred materials of construction are metal and plastic, although there may be some strength restrictions with the plastic models. Preferably, the brackets may be unitary but it is anticipated that the C-shaped portion and the flange may be formed separately and joined after forming.

Each bracket includes an attachment portion to facilitate attachment of a panel member, generally adapted to engage the primary tongue of the first member and the attachment portion is substantially C-shaped. The C-shaped portion is preferably defined by a top wall, a bottom wall and a sidewall linking the two walls, with a longitudinal opening or absent sidewall, opposite the sidewall provided. The sidewall provided will typically be provided with an opening which may contribute to a reduction in material used in the bracket.

The C-shaped attachment portion is preferably sized to closely receive an end of the first member. The top and bottom walls of the C-shaped portion will typically each have a depending portion extending from at or adjacent the edge of the respective wall which is opposite the sidewall, as these portions may assist with the positioning and security of the first member.

Each of the depending portions and the sidewall will also generally include one or more openings to receive fasteners.

The C-shaped attachment portion will typically extend perpendicularly to the flange of the bracket, but it may be parallel to, or angled relative to, the flange in the alternative.

The flange to attach the bracket relative to a surface is normally a planar member or plate. The flange will generally be provided with an opening of the same cross-sectional shape as the end portion of the first member, particularly the rebated portions, in order that the end of the first member be allowed to pass through the flange if necessary.

The flange will usually be provided with attachment openings for attaching the bracket to the surface. Each of the attachment openings will preferably be further provided with an insert portion or member to allow smaller dimension fasteners to be used with a uniform sized opening providing increased utility in use. The insert members will preferably taper inwardly and be provided with a central aperture through which the fastener can extend. The insert member or any of the openings for the fasteners provided will typically have a depression for countersinking a head of the fastener. The insert member preferably reduces the cross-sectional size of the opening.

The rebate portions disclosed above with reference to the first members may also be provided on the second members so a bracket may be used with second members as well as, or instead of the first members.

One major advantage of providing a panel having rebated portions and brackets according to the invention and as described above is that the panel can be positioned in the opening by sliding the members further into or out of the brackets. Once a satisfactory position is achieved, fasteners can then be used to secure the members to the bracket.

The other advantageous functionality is that the configuration of the respective members and particularly the rebated portions provide a user with a vastly more simple to use system, particularly when assembling the panel as the rebates and tongues provide a system of positive location and ensures the correct positioning of the members relative to each other.

Alternatively, the bracket used may have an elongate extension portion instead of a C-shaped channel. In this embodiment, the members may be provided with an opening in the end surface to receive the extension portion resulting in a hidden fixture system.

In a third form, the invention resides in a fixture system to secure an elongate member relative to a support, the fixture system including an opening formed in an end face of the elongate member and a bracket adapted to be mounted to the support and having an elongate extension portion to be received at least partially in the opening in the end face.

In a fourth form, the invention resides in a two-part, self-locating joint for overlapping members, the joint having a first mortise part on a first overlapping member and a second tenon part on a second overlapping member such that the tenon part of the joint positively locates in the mortise part of the joint when the members overlap to ensure correct positioning.

### BRIEF DESCRIPTION OF THE DRAWINGS

Various embodiments of the invention will be described with reference to the following drawings, in which:

FIG. 1 is a perspective view of a bracket used in a preferred embodiment of the present invention.

FIG. 2 is a perspective view of the bracket illustrated in FIG. 1 and laterally displaced from the member to which it attaches, illustrated in FIG. 3.

FIG. 3 is a perspective view of a first member according to a first embodiment of the present invention.

FIG. 4 is a perspective view of the bracket illustrated in FIG. 2 in position relative to the first member illustrated in FIG. 3.

FIG. 5 is a perspective view of a panel according to a particularly preferred embodiment with the fasteners in exploded view and only one bracket used.

FIG. 6 is a perspective view of the bracket illustrated in FIG. 1 and laterally displaced from the member to which it attaches, illustrated in FIG. 7.

FIG. 7 is a perspective view of a first member according to a second embodiment of the present invention.

FIG. 8 is a perspective view of the bracket illustrated in FIG. 6 in position relative to the first member illustrated in FIG. 7.

FIG. 9 is a detailed close-up view of a first end of the first member illustrated in FIG. 7.

FIG. 10 is a detailed close-up view of a second end of the first member illustrated in FIG. 7.

FIG. 11 is a perspective view of both front and back sides of a second member according to a preferred embodiment of the present invention.

FIG. 12 is a perspective view of a bracket according to an alternative embodiment.

FIG. 13 is a rear view of the bracket as illustrated in FIG. 12.

FIG. 14 is a side view of the bracket as illustrated in FIG. 12.

FIG. 15 is a top view of the bracket as illustrated in FIG. 12.

FIG. 16 shows a variety of views of the bracket illustrated in FIG. 12 with an insert portion according to a preferred embodiment.

### DETAILED DESCRIPTION OF THE PREFERRED EMBODIMENT

According to a particularly preferred embodiment of the present invention, a panel is provided.

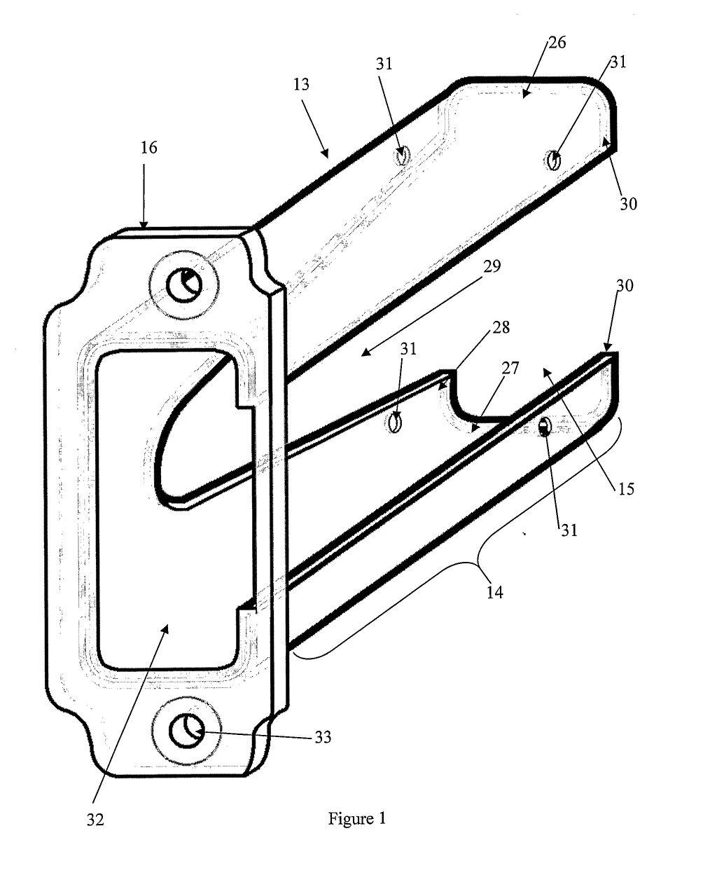

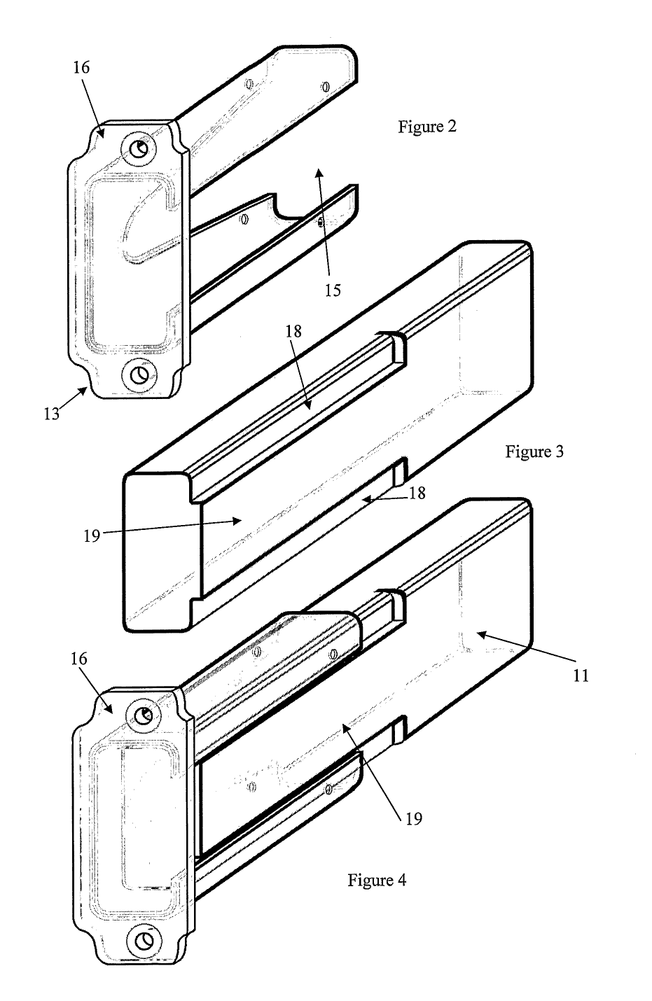

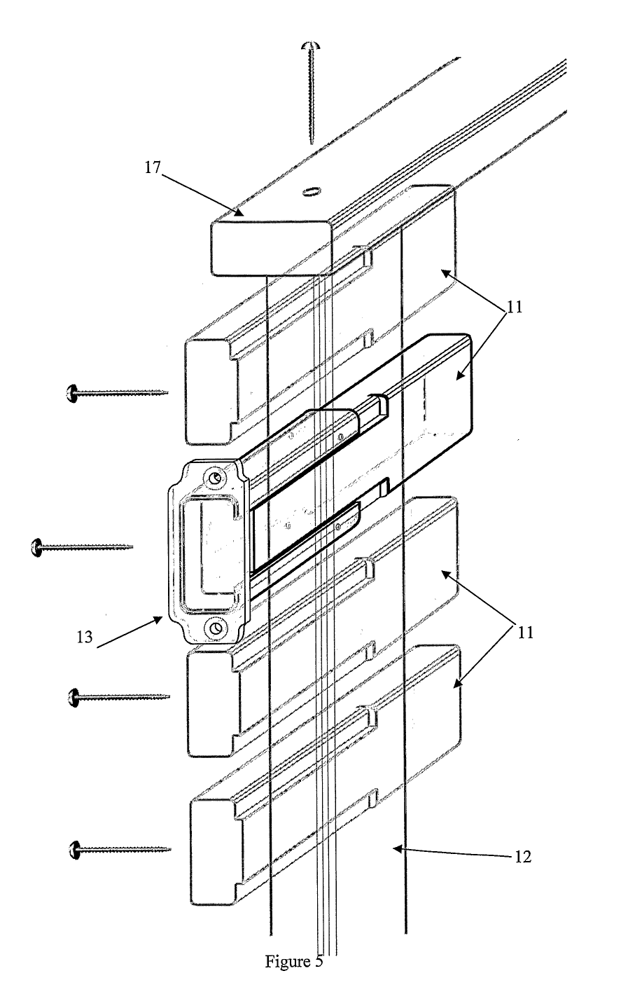

The panel as illustrated in assembled form in FIG. 5 has a plurality of first members 11 disposed in a first direction and a plurality of second members 12 disposed in a second direction. The panel also includes locating brackets 13, best illustrated in FIG. 1 or 2, each locating bracket 13 having a substantially C-shaped attachment portion 14 having an opening 15 along a sidewall and a flange 16 adapted to attach the bracket 13 relative to a surface. At least one side surface of the first member 11 is shaped to engage the C-shaped attachment portion 14 of the locating bracket 13 such that part of the C-shaped attachment portion 14 is adapted to be coplanar with at least one side surface of the first member 11.

The panel illustrated in FIG. 5 has first members 11 in the form of slats alternated with openings between the slats.

According to the panel illustrated in FIG. 5, there are a plurality of first members 11 arrayed in a first direction. A first preferred embodiment of a first member 11 is illustrated in FIGS. 3 and 4. According to this embodiment, each of the first members 11 are elongate slat members. The first members 11 illustrated in FIGS. 3 to 5 are oriented horizontally but direction depends upon the desire of the user.

The first slat members 11 have a rectangular cross-section with the corners of the rectangular slat members 11 smoothed to create a more aesthetically pleasing appearance. The first slat members 11 are oriented such that the longer of the two dimensions is parallel to the longer of the two dimensions of the second members 12.

A first member 11 is also illustrated in FIG. 5, used as a top rail 17 for the panel as well as slats, albeit the top rail being positioned differently to the remainder of the first slat members 11. The top rail 17 is used as a border rail mainly to protect the edges of the second members from water damage but also to tidy the appearance of the panel, and provided further structural support to the panel.

In the embodiment of the panel illustrated in FIG. 5, there is a second member 12 positioned in a second direction, although further second members 12 would be located across the panel. There will usually be a second member 12 provided at each end of the panel and also one or more second members 12 provided along the panel to provide stiffening or bracing to the panel.

The second members 12, best illustrated in FIG. 11, are also elongate members whose length depends upon the size of the panel required. As with the first members 12, each of the second members 12 are slat members. The second slat members 12 have a rectangular cross-section. Again, the corners of the rectangle are smoothed to create a more aesthetically pleasing appearance.

The second members 12 are oriented such that the longer of the two dimensions of the second member 11 is parallel to the longer of the two dimensions of the first members.

As can be seen in FIG. 5, the second members 12 provided at the ends of the panel are adapted to allow the use of the bracket 13 to secure the panel in position by engaging with the first member 11. The coplanar portion of the C-shaped attachment portion 14 of the bracket 13 and the first member 11 with which it engages faces the second member 12 located at the ends of the panel but the bracket 13 does not prevent the abutment of the first 11 and second 12 members.

Each member (first 11 or second 12) has rebated sections. The location and configuration of the rebated sections differ between the first 11 and second 12 members but the rebated sections and any tongues formed by rebating on the first 11 and second 12 members are correspondingly shaped to engage each other when the panel is assembled.

According to the embodiment illustrated in FIG. 3, each first member 11 includes a pair of rebated portions 18 at or adjacent each end of the first member 11. Each of the rebated portions 18 is a shoulder rebate or a portion removed from a corner of the first member 11 over a predetermined length of the first member 11. The rebated portions 18 are formed by removal of material from corners on the same side of the first member 11 and not diagonally opposite corners.

The rebated portions 18 of the first member 11 preferably extend along the first member approximately 75 mm from each end. The rebated portions 18 form a raised tongue 19 on each end of the first member 11 between the rebated portions 18. As illustrated in FIG. 4, the tongue 19 is received between sidewalls of the C-shaped attachment portion 14 of the bracket 13.

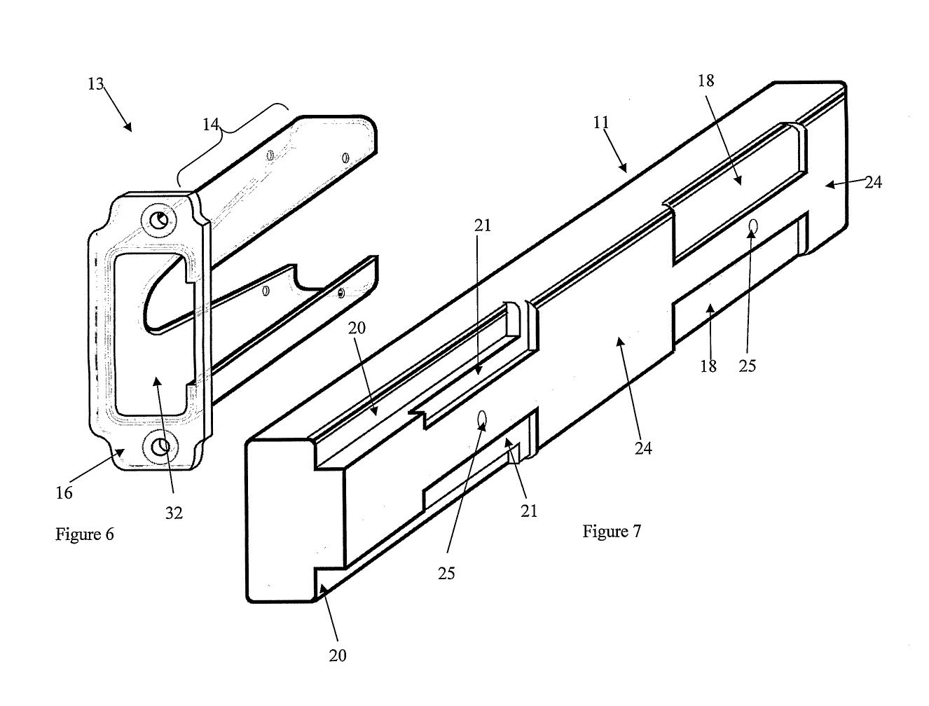

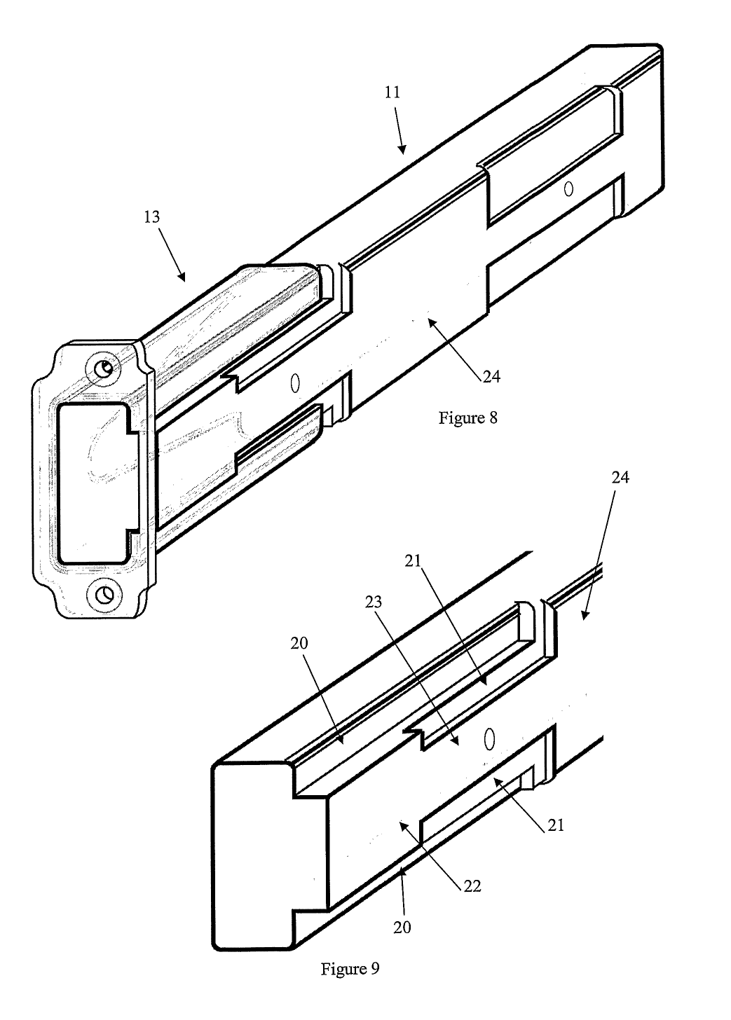

The rebated portion 18 of the first member 11 extend approximately 75 mm inward. This allows positioning of the second member 12, which is approximately 42 mm wide, relative to the first members 11, with approximately 35 mm of overhang of the first member 11 outwardly past the edge of the second member 12. In this instance, once the bracket 13 is fitted to the first member 11, the second member 12 covers the rebated portions 18 of the first member 11. According to an alternative embodiment of the first member 11, illustrated in FIGS. 7 to 9, there may be more than one rebated portion provided at the same end of the first members 11. According to this preferred embodiment, each end of the first member 11 has a pair of primary rebates 20 and a pair of secondary rebates 21 rebated to different depths and positions to form a stepped profile at the end of the first member 11.

The formation of primary rebates 20 forms a primary tongue 22 and this primary tongue 22 is then further rebated to provide the secondary rebates 21. It is the primary tongue 22 which engages with the opening in the sidewall of the C-shaped attachment portion 14 of the bracket 13 to secure the first member 11 to the bracket 13. The secondary rebates 21 are narrower and shallower than the primary rebates 20 and are formed over a part only of the length of the primary rebates 20.

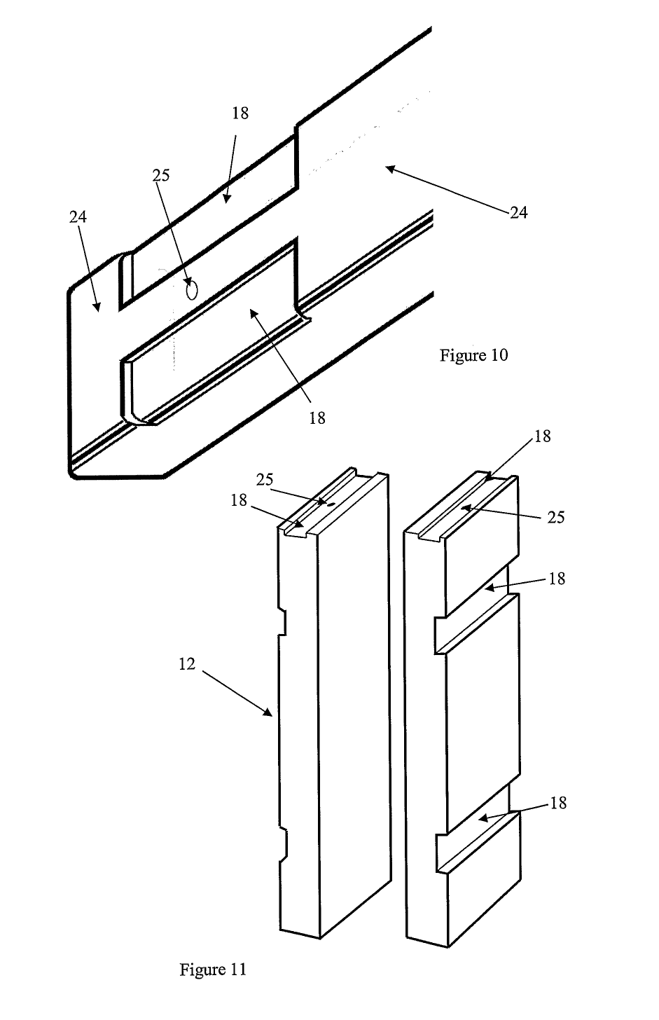

The primary tongue 22 is located adjacent the end of the first member 11 and the secondary rebates form a secondary tongue 23 which is located inboard of the primary tongue 22. When both primary 22 and secondary 23 tongues are provided on an end of the first member 11, the primary tongue 22 is an L-shaped tongue when viewed from the side with a base portion of the L-shaped tongue adjacent the end of the first member and an upright portion of the L-shaped tongue extending from the base portion and toward the opposite end of the first member. The secondary tongue 23 stops at the full-sized or unrebated portion 24 of the first member 11.

Where not provided with the primary 20 and secondary 21 rebate, such as along the length of the first member 11 between the ends or at ends simply not provided with the primary 20 and secondary 21 rebated portions, the rebated portions of the first members 11 are provided at the corner edges similar to the formation of the primary tongue 22 but differ in that they do not extend all the way to the end of the first member 11. Rebated portions such as these are illustrated in FIGS. 7, 9 and 10.

In this form, the rebated portions 18 are separated from the end of the first member 11 by a full-size, unrebated portion 24. Where this type of rebated portion 18 is provided, the depth and width of the rebated portions 18 is similar to that of the secondary tongue 23.

Each of the rebated portions of the first member 11 has a predrilled hole 25 associated with the tongue formed by the rebated portions.

As illustrated in FIG. 11, each of the second members 12 used in the panel according to the invention includes a plurality of rebated portions 18 spaced over their length. Each rebated portion 18 is particularly adapted to engage a secondary tongue 23 provided on a first member 11 to positively locate the first member 11 relative to the second member 12.

Each secondary member 12 has the same configuration and spacing between the rebated portions 18 to align the rebated portions 18 and in turn, align the first member 11 of the panel.

Each second member 11 includes rebated portions 18 in the end surfaces of the member in order to engage with the tongue portions 23 of a first member 11 when used as a top 17 or bottom rail of the panel. Where provided, these rebated portions 18 are centrally located.

Again, each rebated portion 18 has a predrilled hole 25 associated with the rebated portion 18.

The panel of the invention includes multiple locating brackets 13, as illustrated in FIG. 1. Each bracket 13 is typically between 25 mm and 200 mm in length.

The brackets 13 may be manufactured from any relatively light but strong material and preferred materials of construction are metal and plastic, although there may be some strength restrictions with the plastic models. Preferably, the brackets 13 may be unitary but it is anticipated that the C-shaped portion 14 and the flange 16 may be formed separately and joined after forming.

Each bracket 13 includes an attachment portion 14 to facilitate attachment of a first member 11, generally adapted to engage the primary tongue 22 of the first member 11 and the attachment portion 14 is substantially C-shaped. The C-shaped portion 14 is defined by a top wall 26, a bottom wall 27 and a sidewall 28 linking the two walls, with a longitudinal opening 15 or absent sidewall opposite the sidewall 28 provided. The sidewall 28 is provided with an opening 29 which may contribute to a reduction in material used in the bracket 13.

The C-shaped attachment portion 14 is sized to closely receive an end of the first member 11. The top 26 and bottom 27 walls of the C-shaped portion 14 will typically each have a depending portion 30 extending from at, or adjacent to, the edge of the respective wall which is opposite the sidewall 28 to assist with the positioning and security of the first member 11.

Each of the depending portions 30 and the sidewall 28 will also generally include one or more openings 31 to receive fasteners.

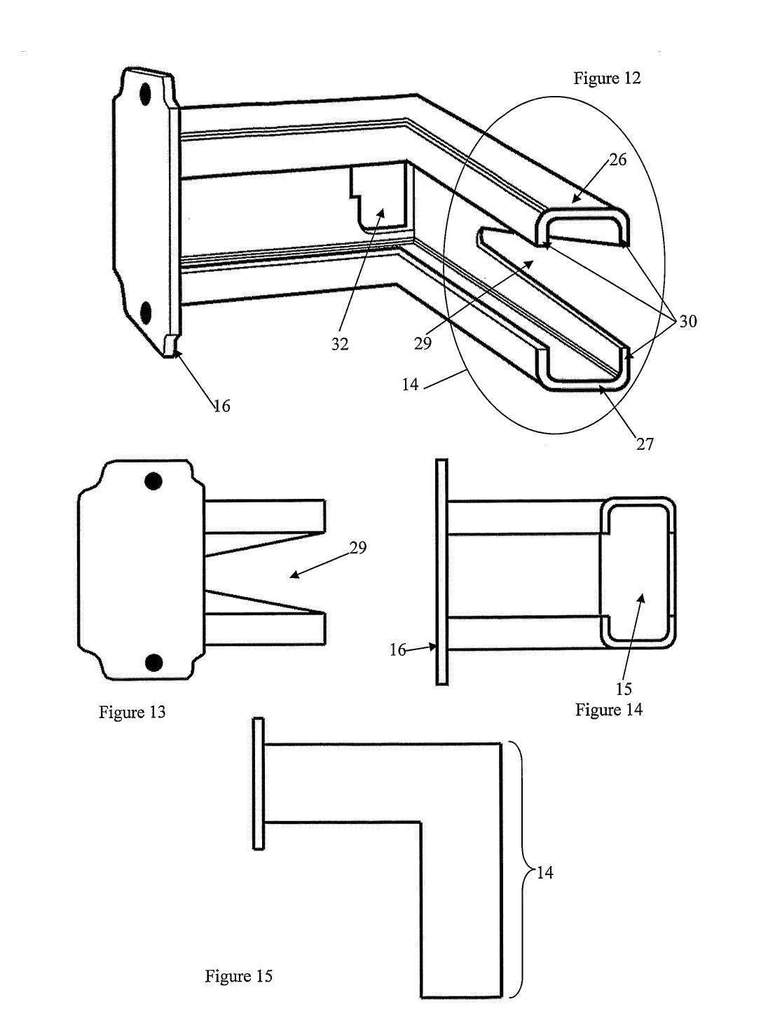

The C-shaped attachment portion 14 extends perpendicularly to the flange 16 of the bracket 13 according to the embodiment illustrated in FIG. 1 but it may be parallel to the flange as illustrated in FIGS. 12 to 15.

The flange 16 to attach the bracket 13 relative to a surface is normally a planar member or plate. The flange 16 is provided with an opening 32 of the same cross-sectional shape as the end portion of the first member 11, particularly the rebated portions, in order that the end of the first member 11 be allowed to pass through the flange 16 if necessary.

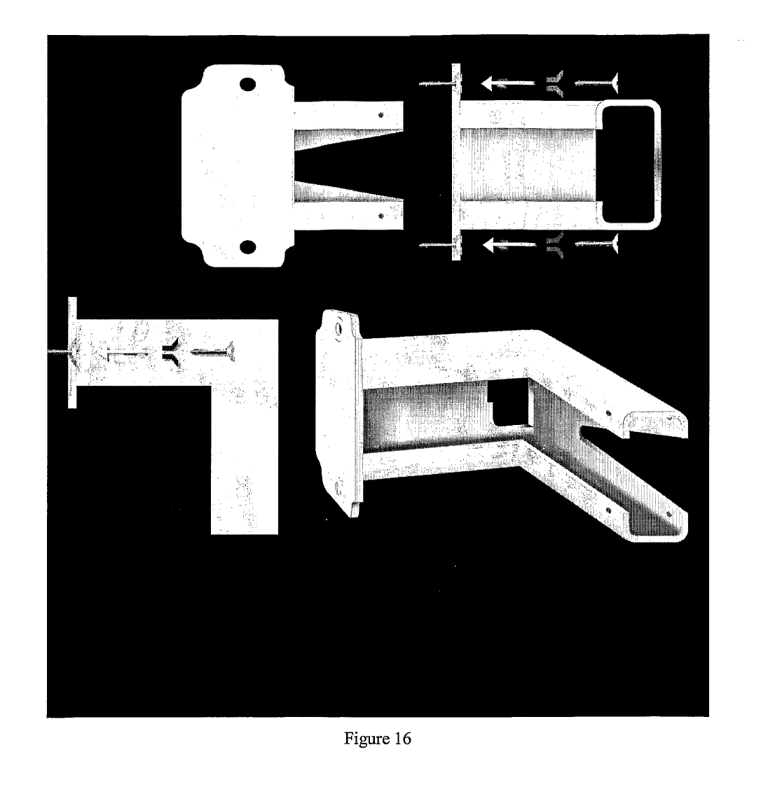

The flange 16 will usually be provided with attachment openings 33 for attaching the bracket 13 to the surface. Insert members are also illustrated in the embodiment of FIG. 16.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A panel comprising:
at least one locating bracket having:
a substantially C-shaped attachment portion having an opening along at least one sidewall; and
a flange adapted to attach the at least one bracket relative to a surface;
a plurality of first members disposed in a first direction;
at least one second member disposed in a second direction; and
at least one side surface of at least one member being shaped to engage the C-shaped attachment portion of the locating bracket, wherein at least a part of the C-shaped attachment portion is adapted to be coplanar with at least one side surface of the at least one member.

2. A panel according to claim 1, wherein the panel is manufactured for sale in kit or modular form.

3. A panel according to claim 1, wherein the panel includes a series of members in the first direction and members in the second direction which fix the members in the first direction together and/or brace the members in the first direction.

4. A panel according to claim 1, wherein each member includes a number of predrilled openings to allow for the use of fasteners.

5. A panel according to claim 1, wherein each member has at least one rebated section, the location and configuration of the rebated sections of the first and second members correspondingly shaped to engage each other when the panel is assembled.

6. A panel according to claim 1, wherein each first member includes a pair of rebated portions adjacent each end of the first member formed by removal of corner portions from corners on the same side of the first member.

7. A panel according to claim 1, wherein an entire end portion of the first member is reduced in size such that the C-shaped attachment portion surrounds the end portion of the first member and is flush with an unrebated portion of the first member.

8. A panel according to claim 6, wherein once a bracket is fitted to a first member, a second member properly located covers the rebated portions of the first member.

9. A panel according to claim 6, wherein the rebated portions form a raised tongue extension portion on each end of the first member between the rebated portions.

10. A panel according to claim 9, wherein the tongue extension portion is received between sidewalls of the C-shaped attachment portion.

11. A panel according to claim 6, wherein each end of the first member has a stepped profile formed by rebates of different depths and/or position.

12. A panel according to claim 9, wherein the tongue extension portion formed by the rebating of the corners of the ends of the first members is a primary rebate and is further rebated to provide at least one secondary rebate portion, narrower and shallower than the primary rebate and is formed over a part only of the length of the primary rebate.

13. A panel according to claim 12, wherein the primary rebate is located adjacent the end of the first member and the secondary rebate portion is located inboard of the primary rebate.

14. A panel according to claim 13, wherein the primary tongue is an L-shaped tongue when viewed from the side with a base portion of the L-shaped tongue adjacent the end of the first member and an upright portion of the L-shaped tongue extending from the base portion and toward the opposite end of the first member.

15. A panel according to claim 1, wherein each first member includes a pair of rebated portions formed by removal of corner portions from corners on the same side of the first member, separated from the end of the first member by a full-size, unrebated portion.

16. A panel according to claim 1, wherein each of the second members include a plurality of rebated portions spaced over their length.

17. A panel according to claim 1, wherein each second member includes rebated portions in the end surfaces of the member in order to engage with a first member when used as a top or bottom rail of the panel.

18. A panel according to claim 1, wherein the C-shaped portion of a bracket is defined by a top wall, a bottom wall and a sidewall linking the two walls, with a longitudinal opening or absent sidewall, opposite the sidewall provided.

19. A panel according to claim 18, wherein the top and bottom walls of the C-shaped portion each have a depending portion extending from the edge of the respective wall which is opposite the sidewall.

20. A panel according to claim 1, wherein the bracket includes a flange extending at an angle from the C-shaped portion and provided with an opening of the same cross-sectional shape as the end portion of the first member.

21. A method for assembling a panel, the panel comprising:
at least one locating bracket having:
a substantially C-shaped attachment portion having an opening along at least one sidewall; and
a flange adapted to attach the at least one bracket relative to a surface;
a plurality of first members disposed in a first direction;
at least one second member disposed in a second direction; and
at least one side surface of at least one member being shaped to engage the C-shaped attachment portion of the bracket, wherein the method includes the step of inserting the member into the C-shaped attachment portion until at least a part of the C-shaped attachment portion is coplanar with at least one side surface of the panel member and securing the bracket to the member.

22. A fixture system to secure an elongate member relative to a support, the fixture system including an opening formed in an end face of the elongate member and a bracket adapted to be mounted to the support and having an elongate extension portion to be received at least partially in the opening in the end face.

23. A two-part, self-locating joint for overlapping members, the joint having a first mortise part on a first overlapping member and a second tenon part on a second overlapping member such that the tenon part of the joint positively locates in the mortise part of the joint when the members overlap to ensure correct positioning.
